(19) United States
(12) Patent Application Publication
(10) Pub. No.: US 2022/0188609 A1
(43) Pub. Date: Jun. 16, 2022

(54) RESOURCE AWARE NEURAL NETWORK MODEL DYNAMIC UPDATING

(71) Applicant: Plantronics, Inc., Santa Cruz, CA (US)

(72) Inventors: Yong YAN, Leander, TX (US); David A. BRYAN, Cedar Park, TX (US)

(21) Appl. No.: 17/124,238

(22) Filed: Dec. 16, 2020

(51) Int. Cl. G06N 3/063; G06N 3/04; G06F 9/50

(52) U.S. Cl. CPC G06N 3/063; G06F 9/5044; G06N 3/04

(57) ABSTRACT

Resources of an embedded system, such as RAM utilization and available processor cycles or bandwidth are monitored. Neural network models of varying size and computational load for given neural networks are utilized in conjunction with this resource monitoring. The neural network model used for a particular neural network is dynamically varied based on the resource monitoring. In one example, neural network models of varying precision are stored and the best model for the available RAM and processor cycles is loaded. In one example, neural network model weight values are quantized before being loaded for use, the level of quantization being based on the available RAM and processor cycles. This dynamic adaption of the neural network models allows other processes in the embedded system to operate normally and yet allows the neural network to operate at the maximum capability allowed for a given period.

### TECHNICAL FIELD

This disclosure relates generally to neural networks, and more particularly to neural networks used on limited resource devices.

### BACKGROUND

Neural networks have found many applications today and more applications are being developed every day. However, current deep neural network models are computationally expensive and memory intensive. For example, the commonly used image classification network ResNet50 takes over 95 MB of RAM for storage and performs over 3.8 billion floating point multiplications. This has created problems when neural networks are to be employed in embedded systems. The large RAM utilization and processor cycle consumption can easily hinder other functions executing on the embedded system, limiting the deployment or forcing the neural network to operate very infrequently, such as at very low frame rates in face finding applications. When used in a videoconferencing application, the frame rates can be so low that tracking individuals for view framing becomes challenged, hindering proper camera tracking of a speaker.

### SUMMARY

In the described examples, resources of an embedded system, such as RAM utilization and available processor cycles or bandwidth are monitored. Neural network models of varying size and computational load for given neural networks are utilized in conjunction with this resource monitoring. The neural network model used for a particular neural network is dynamically varied based on the resource monitoring. In one example, neural network models of varying precision are stored and the best model for the available RAM and processor cycles is loaded. In one example, neural network model weight values are quantized before being loaded for use, the level of quantization being based on the available RAM and processor cycles. This dynamic adaption of the neural network models allows other processes in the embedded system to operate normally and yet allows the neural network to operate at the maximum capability allowed for a given period.

### BRIEF DESCRIPTION OF THE DRAWINGS

For illustration, there are shown in the drawings certain examples described in the present disclosure. In the drawings, like numerals indicate like elements throughout. The full scope of the inventions disclosed herein are not limited to the precise arrangements, dimensions, and instruments shown. In the drawings:

FIG. 1 is an illustration of a videoconferencing device, in accordance with an example of this disclosure.

FIG. 2 is a block diagram of a processing unit, in accordance with an example of this disclosure.

FIG. 3 is a flowchart of operation to select a neural network model based on systems resources, in accordance with an example of this disclosure.

FIG. 4A is an illustration of providing variable size quantized neural network models, in accordance with an example of this disclosure.

FIG. 4B is an illustration of providing variable size compressed K-cluster neural network models, in accordance with an example of this disclosure.

### DETAILED DESCRIPTION

In the drawings and the description of the drawings herein, certain terminology is used for convenience only and is not to be taken as limiting the examples of the present disclosure. In the drawings and the description below, like numerals indicate like elements throughout.

Throughout this disclosure, terms are used in a manner consistent with their use by those of skill in the art, for example:

Computer vision is an interdisciplinary scientific field that deals with how computers can be made to gain high-level understanding from digital images or videos. Computer vision seeks to automate tasks imitative of the human visual system. Computer vision tasks include methods for acquiring, processing, analyzing and understanding digital images, and extraction of high-dimensional data from the real world to produce numerical or symbolic information. Computer vision is concerned with artificial systems that extract information from images. Computer vision includes algorithms which receive a video frame as input and produce data detailing the visual characteristics that a system has been trained to detect.

A convolutional neural network is a class of deep neural network which can be applied analyzing visual imagery. A deep neural network is an artificial neural network with multiple layers between the input and output layers.

Artificial neural networks are computing systems inspired by the biological neural networks that constitute animal brains. Artificial neural networks exist as code being executed on one or more processors. An artificial neural network is based on a collection of connected units or nodes called artificial neurons, which mimic the neurons in a biological brain. Each connection, like the synapses in a biological brain, can transmit a ‘signal’ to other neurons. An artificial neuron that receives a signal then processes it and can signal neurons connected to it. The signal at a connection is a real number, and the output of each neuron is computed by some non-linear function of the sum of its inputs. The connections are called edges. Neurons and edges have weights, the value of which is adjusted as ‘learning’ proceeds and/or as new data is received by a state system. The weight increases or decreases the strength of the signal at a connection. Neurons may have a threshold such that a signal is sent only if the aggregate signal crosses that threshold.

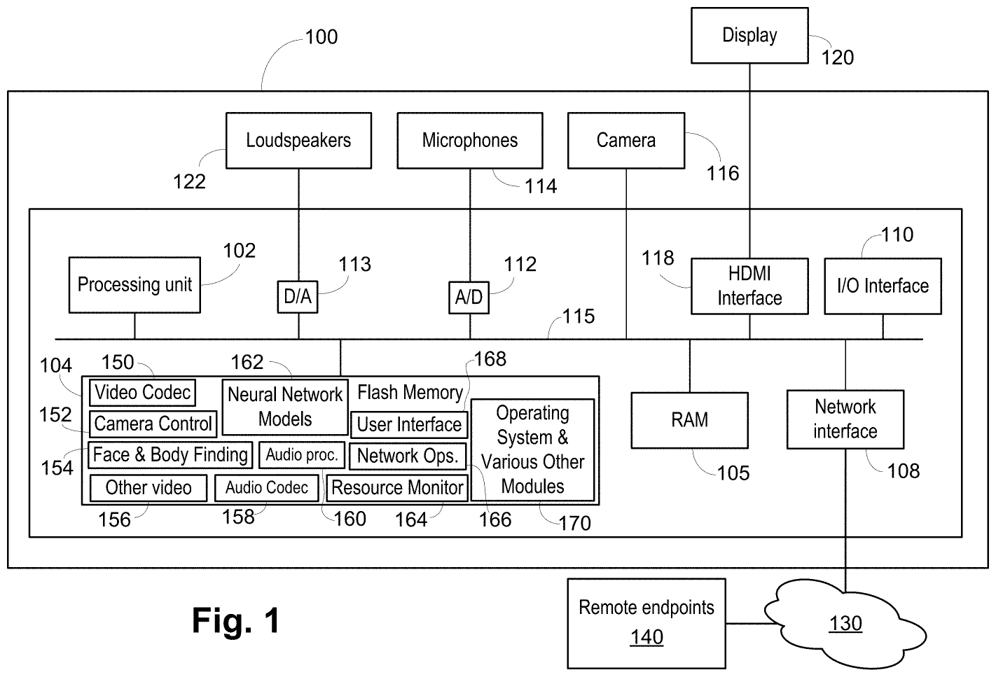

FIG. 1 illustrates aspects of a device 100, in accordance with an example of this disclosure. Typical devices 100 include videoconference endpoints that contain a camera and a display. The device 100 can include cell phones, tablets and other portable devices. The device 100 can include laptop computers, desktop computers with cameras, and the like. The device 100 can include embedded modules, such as vehicle controllers, that utilize neural networking for vision processing, autonomous operation or process control.

The device 100 includes loudspeaker(s) 122, camera(s) 116 and microphone(s) 114 interfaced via interfaces to a bus 115, the microphones 114 through an analog to digital (A/D) converter 112 and the loudspeaker 122 through a digital to analog (D/A) converter 113. The device 100 also includes a processing unit 102, a network interface 108, a flash memory 104, RAM 105, and an input/output general interface 110, all coupled by bus 115. An HDMI interface 118 is connected to the bus 115 and to an external display 120. Bus 115 is illustrative and any interconnect between the elements can used, such as Peripheral Component Interconnect Express (PCIe) links and switches, Universal Serial Bus (USB) links and hubs, and combinations thereof. The cameras 116 and microphones 114 can be contained in a housing containing the other components or can be external and removable, connected by wired or wireless connections.

The processing unit 102 can include digital signal processors (DSPs), central processing units (CPUs), graphics processing units (GPUs), dedicated hardware elements, such as neural network accelerators and hardware codecs, and the like in any desired combination.

The flash memory 104 stores modules of varying functionality in the form of software and firmware, generically programs, for controlling the device 100. Illustrated modules include a video codec 150, camera control 152, face and body finding 154, other video processing 156, audio codec 158, audio processing 160, neural network models 162, resource monitor 164, network operations 166, user interface 168 and operating system and various other modules 170. The RAM 105 is used for storing any of the modules in the flash memory 104 when the module is executing, storing video images of video streams and audio samples of audio streams and can be used for scratchpad operation of the processing unit 102. Relevant to this description is that the neural network models 162 are loaded into the RAM 105 when the respective neural network is being used, such as for face and body finding, background detection and other operations that vary based on the actual device.

The network interface 108 enables communications between the device 100 and other devices and can be wired, wireless or a combination. In one example, the network interface is connected or coupled to the Internet 130 to communicate with remote endpoints 140 in a videoconference. In one or more examples, the general interface 110 provides data transmission with local devices such as a keyboard, mouse, printer, projector, display, external loudspeakers, additional cameras, and microphone pods, etc.

In one example, the cameras 116 and the microphones 114 capture video and audio, respectively, in the videoconference environment and produce video and audio streams or signals transmitted through the bus 115 to the processing unit 102. In at least one example of this disclosure, the processing unit 102 processes the video and audio using algorithms in the modules stored in the flash memory 104. Processed audio and video streams can be sent to and received from remote devices coupled to network interface 108 and devices coupled to general interface 110. This is just one example of the configuration of a device 100.

In a second configuration, the components are disaggregated or separated. In this second configuration, the camera and a set of microphones used for speaker location are in separate camera component with its own processing unit and flash memory storing software and firmware. In such a configuration, the camera control module 152, the face and body finding module 154, and the neural network models 162 are present in the camera component, the camera component then performing the neural network processing used in face and body finding, for example. The camera component provides properly framed video to a codec component. The codec component also has its own processing unit and flash memory storing software and firmware. In this second configuration, the remaining modules in the flash memory 104 of FIG. 1 are in the codec component.

Other configurations, with differing components and arrangement of components, are well known for both videoconferencing endpoints and for devices used in other manners.

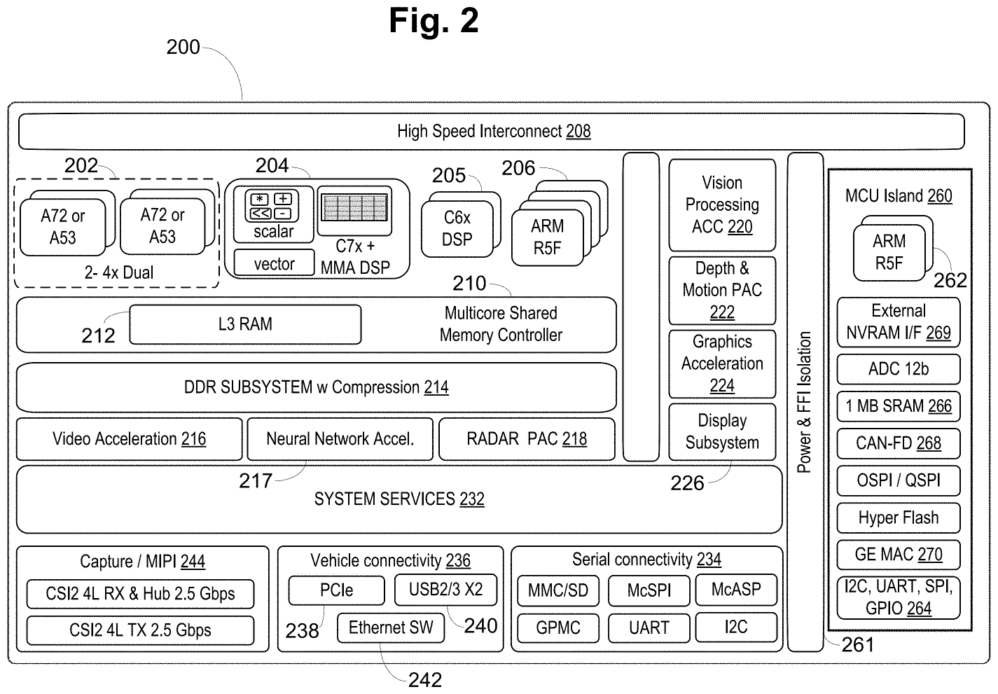

FIG. 2 is a block diagram of an exemplary system on a chip (SoC) 200 as can be used as the processing unit 102. A series of more powerful microprocessors 202, such as ARM® A72 or A53 cores, form the primary general-purpose processing block of the SoC 200, while a more powerful digital signal processor (DSP) 204 and multiple less powerful DSPs 205 provide specialized computing capabilities. A simpler processor 206, such as ARM R5F cores, provides general control capability in the SoC 200. The more powerful microprocessors 202, more powerful DSP 204, less powerful DSPs 205 and simpler processor 206 each include various data and instruction caches, such as L1I, L1D, and L2D, to improve speed of operations. A high-speed interconnect 208 connects the microprocessors 202, more powerful DSP 204, simpler DSPs 205 and processors 206 to various other components in the SoC 200. For example, a shared memory controller 210, which includes onboard memory or SRAM 212, is connected to the high-speed interconnect 208 to act as the onboard SRAM for the SoC 200. A DDR (double data rate) memory controller system 214 is connected to the high-speed interconnect 208 and acts as an external interface to external DRAM memory. A video acceleration module 216 and a radar processing accelerator (PAC) module 218 are similarly connected to the high-speed interconnect 208. A neural network acceleration module 217 is provided for hardware acceleration of neural network operations. A vision processing accelerator (VPACC) module 220 is connected to the high-speed interconnect 208, as is a depth and motion PAC (DMPAC) module 222.

A graphics acceleration module 224 is connected to the high-speed interconnect 208. A display subsystem 226 is connected to the high-speed interconnect 208 to allow operation with and connection to various video monitors. A system services block 232, which includes items such as DMA controllers, memory management units, general-purpose I/O's, mailboxes and the like, is provided for normal SoC 200 operation. A serial connectivity module 234 is connected to the high-speed interconnect 208 and includes modules as normal in an SoC. A vehicle connectivity module 236 provides interconnects for external communication interfaces, such as PCIe block 238, USB block 240 and an Ethernet switch 242. A capture/MIPI module 244 includes a four-lane CSI-2 compliant transmit block 246 and a four-lane CSI-2 receive module and hub.

An MCU island 260 is provided as a secondary subsystem and handles operation of the integrated SoC 200 when the other components are powered down to save energy. An MCU ARM processor 262, such as one or more ARM R5F cores, operates as a master and is coupled to the high-speed interconnect 208 through an isolation interface 261. An MCU general purpose I/O (GPIO) block 264 operates as a slave. MCU RAM 266 is provided to act as local memory for the MCU ARM processor 262. A CAN bus block 268, an additional external communication interface, is connected to allow operation with a conventional CAN bus environment in a vehicle. An Ethernet MAC (media access control) block 270 is provided for further connectivity. External memory, generally non-volatile memory (NVM) such as flash memory 104, is connected to the MCU ARM processor 262 via an external memory interface 269 to store instructions loaded into the various other memories for execution by the various appropriate processors. The MCU ARM processor 262 operates as a safety processor, monitoring operations of the SoC 200 to ensure proper operation of the SoC 200.

It is understood that this is one example of an SoC provided for explanation and many other SoC examples are possible, with varying numbers of processors, DSPs, accelerators and the like.

In the example where the device 100 is a videoconferencing device, all of the illustrated modules in the flash memory 104 are executing concurrently during a videoconference. Camera 116 is providing a video stream which is being analyzed by the face and body finding module 154 using the neural network models 162. The video codec 150 and other video processing module 156 are operating on the resulting stream, with camera control module 152 focusing the camera on the speakers as determined by the face and body finding module 154. The audio processing module 160 is operating on speech of the participants of the videoconference provided by the microphones 114, with the resulting speech being provided through the audio codec 158. The network operations module 166 is operating to provide the outputs of the video codec 150 and the audio codec 158 to the far end and to provide the far end audio and video data to the video codec 150 and the audio codec 158 for decoding and presentation on the display 120 and reproduction on the loudspeakers 122. User interface module 168 is operating to allow user control of the various devices and the layout of the display 120. The operating system and various other modules 170 are operating as necessary to allow the device 100 to operate. The resource monitor module 164 is operating to monitor the use and loading of all of the various components for resource scheduling.

The concurrent operation of this many modules often puts a strain on the processing capabilities of the processing unit 102, even one as complex and capable as the SoC 200. Not only are many of the modules operating concurrently, some of the modules are also replicated and the multiple instances are running concurrently. For example, if the device 100 is acting as a videoconferencing bridge, multiple instances of the video codec 150 and the audio codec 158 will be executing for each of the remote endpoints and the network operations module 166 will be interfacing with each of those remote endpoints. Additional modules not shown, such as the modules to combine the various audio streams and the video streams would also be executing on the processing unit 102. This provides an even greater burden on the processing unit 102. Alternatively, if the videoconference is a peer-to-peer videoconference, multiple instances of the video codec 150, audio codec 158 and network operations module 166 will be executing for each of the endpoints in the videoconference. The situation can be further exacerbated if the protocol used in the videoconference is scalable video coding (SVC), which actually produces multiple video streams at different resolutions, which creates the need for further instances of the video codec 150 in operation.

For example, if the device 100 is in a single point videoconference with a single remote endpoint, only single instances of the various modules would be executing. However, when a second endpoint remote endpoint is added to the videoconference, additional instances of the video codec 150, audio codec 158 and other modules as needed would be spawned and begin executing. While performance may be acceptable for the processing unit 102 for this three party peer-to-peer videoconference, when a fourth remote endpoint is added, the processing unit 102 may now have exceeded capabilities under certain circumstances, particularly if the videoconference is being conducted using SVC.

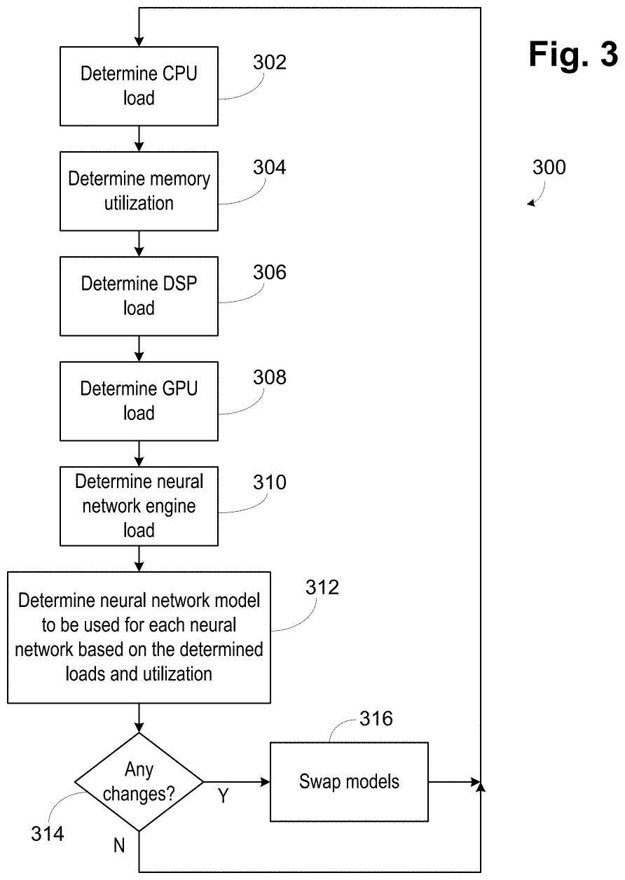

Referring now to FIG. 3, operation of the resource monitor module 164 is illustrated in flowchart 300. In step 302, the resource monitor module 164 determines the CPU load, such as the load on the processors 202 and 206. In step 304, the memory utilization, specifically the RAM 105 utilization, is determined. In step 306, the utilization and load of the various DSPs, such as DSP 204 and DSPs 205, in the processing unit 102 are determined. In step 308, loading of the graphics processing unit (GPU), such as the graphics acceleration module 224, in the processing unit 102 is determined. In step 310, the loading of a neural network engine, such as the neural network accelerator module 217, in the processing unit 102 is determined.

As discussed above, neural network models are used for face and body finding, background finding and the like. In step 312, the particular neural network model to be used for each neural network which is operating is selected or determined. This selection or determination is based on the loads and utilizations as determined in the steps 302-310. If the DSP load, the RAM utilization, and so on are high, a simpler, less complex neural network model is used to minimize resource drain on the other necessary modules of the device 100. If, instead, the DSP load and memory utilization, for example, are low, a higher quality neural network model can be utilized to provide enhanced results for face and body finding and the like. Alternatively, if the DSP load is high and the GPU load is low, a neural network model that primarily utilizes the GPU instead of the DSP can be utilized, with a quality based on the GPU load. The selection of the neural network model can change quality or specific processing unit, or both, depending on resource availability, loading and utilization. Step 312 selects the appropriate neural network model based on the various loading and utilization conditions. In step 314, it is determined if there are any changes from the currently executing neural network models. If not, operation returns to step 302 to again determine the resource loading. Though shown as a loop for continuous operation, a delay can be included so that the resource determination is only performed periodically. The periods can vary from values such as five to ten seconds to thirty seconds. Specific values vary based on components and processing tasks and are determined for a particular instance by tuning the value for the specific environment. If changes are necessary as determined in step 314, in step 316 neural network models are swapped to the newly determined neural network models. In this manner, the highest quality neural network model appropriate for the device 100 operating circumstances is provided, so that the device 100 and the processing unit 102 are not overloaded and thus impairing operation of the device 100.

It is understood that the specific elements whose loading or utilization is being determined can vary as needed for the particular environment. In some examples, GPU loading is minimal in all instances, so the GPU load determination of step 308 can be omitted. In many cases, the neural networks are programs operating on the DSPs, so step 310 can be omitted as it is incorporated in step 306. In some examples, the load determinations can be finer grained. For example, the DSP loading of step 306 can be done per DSP or per DSP task group, such as neural network processing. Similarly, CPU loading as determined in step 302 can be finer grained, per processor or per task type.

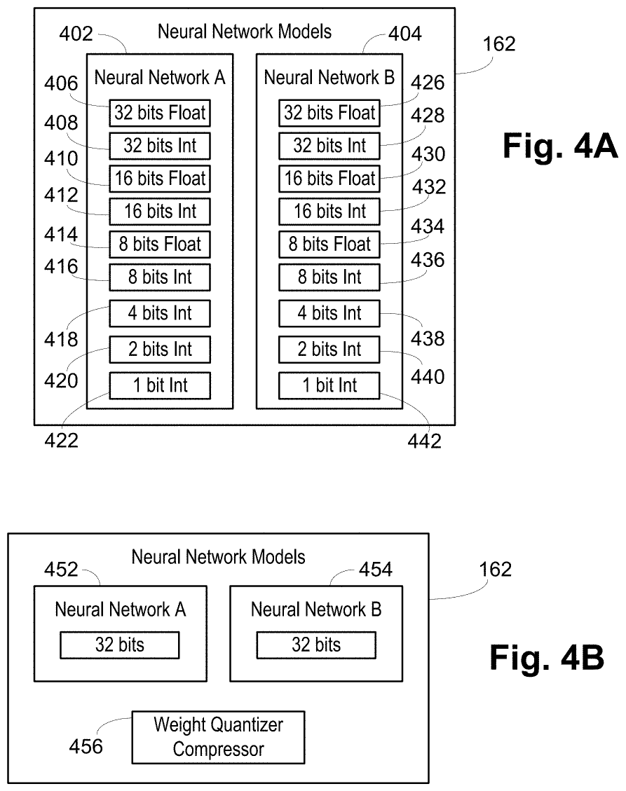

To maintain satisfactory loading levels, various versions of the neural network models are present to allow this proper resource tuning. FIGS. 4A and 4B illustrate alternatives for providing neural network models of varying resource requirements for a given specific processing unit, such as DSP or GPU. FIG. 4A illustrates a first example of the neural network models 162. A neural network A 402 and a neural network B 404 are illustrated. Each neural network A and B 402, 404 contains the models for that neural network at varying levels of precision. The illustrated example of neural network A 402 specific precisions are 32-bit floating-point 406, 32-bit integer 408, 16-bit floating-point 410, 16-bit integer 412, eight bit floating-point 414, eight bit integer 416, four bit integer 418, two bit integer 420 and 1-bit integer 422. Similarly, the neural network B 404 has precisions of 32-bit floating-point 426, 32-bit integer 428, 16-bit floating-point 430, 16-bit integer 432, eight bit floating-point 434, eight bit integer 436, four bit integer 438, two bit integer 440 and 1-bit integer 442. Each of these models has differing RAM requirements and processing requirements. For example, a 32-bit floating-point model of the neural network ResNet50 requires 95 MB of RAM and 3.8 billion floating point operations, a very large amount, particularly on a resource-limited embedded processor. The 32-bit floating-point model 406 will have the highest RAM requirements and processing requirements, whereas the 4-bit integer model 418 will have the lowest memory requirements and processing requirements. Memory requirements vary based on the bit size of the neural network parameters, so 32-bit parameter values occupy double the space of 16-bit parameter values and four times the space of 8-bit parameter values. Changing between floating point and integer and changing bit size changes performance based on the construction of the relevant processor. In one example, a DSP can perform one 32-bit floating point multiply in four cycles, a 16-bit floating point multiply in one cycle, four 32-bit integer multiplies in one cycle, and sixteen 16-bit integer multiplies in one cycle. As the exemplary ResNet50 neural network performs over 3.8 billion multiplications in analyzing a single image, changing bit sizes and floating point to integer has a dramatic change on the processing requirements. The resource monitor module 164 determines the available RAM 105 and processing cycles of the processing unit 102 available for neural network A 402 and selects from the particular models 406-418 provide the desired version of the quantized neural network A 402.

The flash memory 104 stores each of the specific neural network models at each level of quantization or precision. The total space occupied by the neural network models is then relatively large, but the flash memory 104 is relatively large, compared to the RAM 105, so this replication of varying precision neural network models in the flash memory 104 does not pose the problem of the large neural network models being used in the RAM 105.

FIG. 4B illustrates a different set of neural network models from the neural network models 162 of FIG. 4A. In the example of FIG. 4B, neural network A 452 and neural network B 454 are 32-bit floating-point precision. A weight quantizer compressor 456 is utilized to compress the neural networks A and B 452 and 454. The weight values are quantized or clustered into differing binary numbers of weights based on the needed compression. Using ResNet50 as an example, ResNet50 has approximately 23 million parameters. Twenty-five bits would be required to quantize the 23 million parameters, assuming that each is unique. Quantizing to a 16-bit value results in the possibility of just 65,536 or 2¹⁶ different parameter values. Quantizing to 12-bit values results in 4,096 different parameter values. Quantizing to 8-bit values results in the possibility of just 256 different parameter values. Thus, quantizing the number of unique parameter values can dramatically reduce the number of different parameters, and thus RAM size required to store the parameters. Formulaically the RAM size compression rate for the quantization operation is expressed by:

$$R = \frac{N * B}{( N * {log}_{2} ( K ) + K * B )}$$

where N is the number of connections
B is the number of bits
K is the number of clusters in K-means clustering

Computation speed is increased using quantization. For the ResNet50 example, the weight values must be stored in external DRAM because of the size. Quantizing reduces the number of actual weight values, allowing a portion of the weight values to be cached in the relevant processor. For example, if 8-bit quantization is used, the 256 32-bit weight values will all be stored in the relevant L1D cache. In one example, the retrieval time from the L1D cache is just one cycle, as opposed to many cycles from external DRAM. This single cycle retrieval time versus the many cycles for external DRAM provides a computation speed increase. Varying the number of bits in the quantization varies the number of weight values retained in the L1D and L2D caches, which in turn varies the computation speed increase.

The weight quantizer compressor 456 cooperates with the resource monitoring module 164 to set the number of clusters or quantization bits to provide a neural network model of the desired size and computation speed to match the desired RAM utilization and computation overhead.

It is understood that changing the precision or quantization of the neural network will change the accuracy of the analysis performed by the neural network, but this change in precision is preferable to starving other functions of RAM or processor cycles or reducing the frequency of the neural network operations.

In various examples the neural network models of both FIGS. 4A and 4B have been pruned as part of their development process. The pruning of the neural network models of FIG. 4A may vary based on the precision of the model.

In other examples, the storage of models of differing precision as in FIG. 4A can be combined with the weight value quantization of the models of FIG. 4B to provide higher granularity in the selection of models based on the RAM utilization and processor cycles available.

The illustrated precision variances and weight value quantization are two examples of variable compression that can be used to size the neural network model adaptively to available RAM and processor cycles. Other methods of neural network model compression can be utilized as well. For example, low-rank tensor factorization can be used, in which the order of the factorization is adjustable, with higher orders used when the available RAM and processor cycles are high and lower orders used as the available RAM and processor cycles are reduced.

In some examples, each neural network operating in the device is dynamically sized, while in other examples only specific neural networks are dynamically sized and other neural networks have a fixed size.

It is understood that, while the detailed examples used herein are for a videoconferencing unit, the adaptive sizing of neural network models based on RAM utilization and available processor cycles is generally applicable to any embedded system utilizing neural networks, such as vehicles for advanced driver assistance systems (ADAS) applications, robots for vision and movement processing, augmented reality, security and surveillance, cameras and the like.

By periodically monitoring the available RAM and various processor cycles available, differing size and processing requirement neural network models can be utilized adaptively to maximize the quality of the neural network output while also ensuring that other functions using the embedded processor are not starved of RAM or processing cycles.

The various examples described are provided byway of illustration and should not be construed to limit the scope of the disclosure. Various modifications and changes can be made to the principles and examples described herein without departing from the scope of the disclosure and without departing from the claims which follow.

1. A method of operating a device which includes operating neural networks, the device having a processor and RAM and executing a plurality of modules of varying functionality, including at least one neural network, the method comprising:
periodically determining RAM utilization and available processor cycles of the device;
selecting a neural network model for the at least one neural network based on the periodic determination of RAM utilization and available processor cycles; and
executing the selected neural network model as the at least one neural network.

2. The method of claim 1, wherein there are a plurality of neural networks executing on the device, and
wherein the selecting a neural network model and executing the selected neural network model are performed for each of the plurality of neural networks.

3. The method of claim 1, wherein there are a plurality of neural networks executing on the device, and
wherein the selecting a neural network model and executing the selected neural network model are performed for at least one neural network but less than all of the plurality of neural networks.

4. The method of claim 1, wherein there are a plurality of neural network models for the at least one neural network, the plurality of neural network models differing in precision of the weights, and
wherein the selecting a neural network model includes selecting one of the plurality of neural network models based on the precision of the neural network model.

5. The method of claim 4, wherein the precisions differ by bit sizes and floating point or integer.

6. The method of claim 4, wherein the neural network model weight values are quantized,
wherein the selecting a neural network model includes determining a level of quantization of the neural network model weight values, and
wherein both the selection of the precision and the level of quantization are based on the RAM utilization and available processor cycles.

7. The method of claim 1, wherein the neural network model weight values are quantized,
wherein the selecting a neural network model includes determining a level of quantization of the neural network model weight values, and
wherein the level of quantization is based on the RAM utilization and available processor cycles.

8. A device comprising:
RAM;
a processor coupled to the RAM for executing programs; and
memory coupled to the processor for storing programs executed by the processor, the memory storing programs executed by the processor to perform the operations of:
executing a plurality of programs of varying functionality, including at least one neural network;
periodically determining RAM utilization and available processor cycles of the device;
selecting a neural network model for the at least one neural network based on the periodic determination of RAM utilization and available processor cycles; and
executing the selected neural network model as the at least one neural network.

9. The device of claim 8, wherein there are a plurality of neural networks executing on the device, and
wherein the selecting a neural network model and executing the selected neural network model are performed for each of the plurality of neural networks.

10. The device of claim 8, wherein there are a plurality of neural networks executing on the device, and
wherein the selecting a neural network model and executing the selected neural network model are performed for at least one neural network but less than all of the plurality of neural networks.

11. The device of claim 8, wherein there are a plurality of neural network models for the at least one neural network, the plurality of neural network models differing in precision of the weights,
wherein the selecting a neural network model includes selecting one of the plurality of neural network models based on the precision of the neural network model, and
wherein each of the plurality of neural network models is stored in the memory.

12. The device of claim 11, wherein the precisions differ by bit sizes and floating point or integer.

13. The device of claim 11, wherein the neural network model weight values are quantized,
wherein the selecting a neural network model includes determining a level of quantization of the neural network model weight values, and
wherein both the selection of the precision and the level of quantization are based on the RAM utilization and available processor cycles.

14. The device of claim 8, wherein the neural network model weight values are quantized,
wherein the selecting a neural network model includes determining a level of quantization of the neural network model weight values, and
wherein the level of quantization is based on the RAM utilization and available processor cycles.

15. A non-transitory processor readable memory containing programs that when executed cause a processor to perform the following method of operating a device which includes operating neural networks, the device having a processor and RAM and executing a plurality of modules of varying functionality, including at least one neural network, the method comprising:
periodically determining RAM utilization and available processor cycles of the device;
selecting a neural network model for the at least one neural network based on the periodic determination of RAM utilization and available processor cycles; and
executing the selected neural network model as the at least one neural network.

16. The non-transitory processor readable memory of claim 15, wherein there are a plurality of neural networks executing on the device, and
wherein the selecting a neural network model and executing the selected neural network model are performed for each of the plurality of neural networks.

17. The non-transitory processor readable memory of claim 15, wherein there are a plurality of neural networks executing on the device, and
wherein the selecting a neural network model and executing the selected neural network model are performed for at least one neural network but less than all of the plurality of neural networks.

18. The non-transitory processor readable memory of claim 15, wherein there are a plurality of neural network models for the at least one neural network, the plurality of neural network models differing in precision of the weights, and
wherein the selecting a neural network model includes selecting one of the plurality of neural network models based on the precision of the neural network model.

19. The non-transitory processor readable memory of claim 18, wherein the precisions differ by bit sizes and floating point or integer.

20. The non-transitory processor readable memory of claim 15, wherein the neural network model weight values are quantized,
wherein the selecting a neural network model includes determining a level of quantization of the neural network model weight values, and
wherein the level of quantization is based on the RAM utilization and available processor cycles.
